(19) United States
(12) Patent Application Publication
(10) Pub. No.: US 2026/0089135 A1
(43) Pub. Date: Mar. 26, 2026

(54) ADNS TELEMETRY

(71) Applicant: Palo Alto Networks, Inc., Santa Clara, CA (US)

(72) Inventors: Yu-Hsiang Kao, San Jose, CA (US); Damini Kumari Harnathka, Newark, CA (US); Kashyap Tavarekere Ananthapadmanabha, San Jose, CA (US)

(21) Appl. No.: 18/894,889

(22) Filed: Sep. 24, 2024

(51) Int. Cl. H04L 61/4511; H04L 9/40; H04L 61/58

(52) U.S. Cl. CPC H04L 61/4511; H04L 61/58; H04L 63/14

(57) ABSTRACT

The present application discloses a method, system, and computer system for providing advanced domain name system (ADNS) telemetry data. The method includes (i) cache ADNS telemetry data in an ADNS telemetry cache in a local security platform, and (ii) send the cached ADNS telemetry data from the local security platform to a cloud security service in near real time for a real-time threat analysis using ADNS telemetry.

### BACKGROUND OF THE INVENTION

The Domain Name System (DNS) is a critical component of the internet's infrastructure, responsible for translating human-readable domain names into machine-readable IP addresses. As the volume and complexity of internet traffic continue to grow, monitoring and analyzing DNS traffic, commonly referred to as DNS telemetry, has become increasingly important for ensuring network performance, security, and integrity.

DNS hijacking, also known as DNS redirection, is a malicious attack in which the DNS settings are changed to redirect traffic to fraudulent websites. This can lead to severe consequences, including the theft of sensitive information, financial losses, and damage to the reputation of the targeted entities. DNS hijacking can occur through various methods, such as compromising DNS servers, altering DNS settings on individual computers, or exploiting vulnerabilities in network equipment. Once a DNS record has been hijacked, users attempting to visit a legitimate website are instead directed to a malicious site, often without their knowledge. This type of attack is particularly insidious because it can be difficult to detect and may go unnoticed for extended periods. Traditional methods of detecting DNS hijacking can be resource-intensive and may not provide timely detection. Moreover, attackers may use sophisticated techniques to evade detection, such as rapidly changing the hijacked DNS records or using multiple layers of redirection.

DNS telemetry data can provide valuable insights into network operations, user behavior, and potential security threats. However, efficiently collecting, storing, and processing this telemetry data presents significant technical challenges, particularly in high-traffic environments.

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system to handle DNS requests and DNS responses according to various embodiments.

FIG. 3 is an illustration of a system for caching and reporting DNS telemetry data according to various embodiments.

FIG. 4 is an illustration of an advance domain name system (ADNS) telemetry cache according to various embodiments.

FIG. 5 is a flow diagram of a method for providing DNS telemetry data according to various embodiments.

FIG. 6 is a flow diagram of a method for storing DNS telemetry data in an ADNS telemetry cache according to various embodiments.

FIG. 7 is a flow diagram of a method for determining whether to store DNS telemetry data in an ADNS telemetry cache according to various embodiments.

FIG. 8 is a flow diagram of a method for storing DNS telemetry data in an ADNS telemetry cache according to various embodiments.

FIG. 9 is a flow diagram of a method for providing DNS telemetry data according to various embodiments.

FIG. 10 is a flow diagram of providing information pertaining to ADNS telemetry cache according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a Domain Name System (DNS) resolver, a computer, a tablet, a laptop, a smartphone, etc. Various other devices may be implemented as a security entity. As another example, a security entity may be implemented as an application running on a device, such as an anti-malware application.

As used herein, an NXDomain response is a type of DNS response that is provided to a client/browser (e.g., in response to a DNS query) when the domain or website associated with the corresponding DNS query does not exist. For example, the domain or website does not exist within the database of the DNS server that is processing the DNS query. As another example, the NXDomain response may include a packet indicating that the DNS server cannot identify a DNS record for the website or domain in its database.

As used herein, DNS telemetry data may include data related to the DNS queries and responses that occur when devices connect to the internet. This data can be used to provide insights into network performance, security, and user behavior. DNS telemetry can include information such as: query data and DNS response data. The query data may include domain names being queried, the source IP addresses of the queries, the timing of the queries, and the types of records being requested (e.g., A, AAAA, CNAME, MX records). The response data can comprise IP addresses returned in response to DNS queries, the time it takes to resolve these queries, and any errors or failures in the resolution process. According to various embodiments, DNS telemetry data comprises one or more of (i) general information, (ii) response cache hit data, and (iii) NXDomain data.

DNS telemetry data is often used by network administrators, cybersecurity professionals, and service providers to monitor network health, optimize DNS performance, and detect security threats. For example, network administrators may want to identify domains having a relatively high ADNS local cache hit rate because a higher ADNS local cache hit rate can reduce the network bandwidth usage to the cloud, the dynamic memory usage and CPU usage of the core FW engine, and the chances of ADNS “fail open” (e.g., an instance where DNS traffic is permitted to pass as a result of the firewall not obtaining a verdict within a threshold period of time, such as 10 ms).

Traditional approaches to DNS telemetry collection often rely on continuously streaming data to centralized processing systems, which can lead to significant network overhead, latency, and potential data loss, especially during peak traffic periods. Additionally, these methods can introduce complexities in terms of data management, as the continuous flow of telemetry data can overwhelm storage and processing resources, making it difficult to perform timely analysis.

To address these challenges, there is a need for systems and methods that can efficiently cache DNS telemetry data locally, reduce network overhead, and ensure that telemetry data is transmitted to centralized processing systems in a controlled and reliable manner.

Various embodiments provide a system and method for caching DNS telemetry data in an advanced DNS (ADNS) telemetry cache. The ADNS telemetry cache is divided into two parts, each of which is alternately toggled between active and inactive states over a predefined time interval or cycle time. During one cycle, a first part of the ADNS telemetry cache is set as active, allowing for the storage of telemetry data collected during that cycle.

Concurrently, the second part of the ADNS telemetry cache is set as inactive, during which time the telemetry data stored in that part is transmitted to a cloud security service for further analysis and processing.

By implementing this toggle mechanism, the system ensures that DNS telemetry data is continuously collected without interruption, while also providing an efficient method for transmitting data to external processing systems. This approach reduces network overhead by minimizing the frequency of data transmissions and ensures that telemetry data is securely and reliably sent to the cloud security service. Additionally, the use of a predefined cycle time allows for the system to be customized based on network conditions, traffic volume, and security requirements.

DNS telemetry data can be used to provide a detection service (e.g., a security service that classifies DNS traffic) with data to build a customer DNS profile. In some embodiments, the system uses the current MICA channel as a telemetry channel over which to report (e.g., send) the DNS telemetry data collected (e.g., locally at a security entity such as a firewall) to the security service. The system can provide to the security service information pertaining to the response cache hits locally at the security entity.

The bandwidth between a security entity and the security service (e.g., a cloud security platform) is limited. Because the security entity reports various types of information that have higher priority than DNS telemetry data, the bandwidth that can be allocated for the sending of DNS telemetry data is constrained. Inspection traffic is generally deemed higher priority than DNS telemetry data, for example, because although DNS telemetry data can be used to identify DNS activity and trends, inspection traffic can help a security system (e.g., the customer of the security platform) immediately navigate a current attack. Inspection traffic may include requests for the security service to classify certain network traffic (e.g., DNS responses, etc.) and to receive the classifications determined (e.g., predicted) by the security service. Accordingly, DNS telemetry data is often deemed as auxiliary data.

DNS telemetry data can be used to build a portfolio of network traffic characterizations observed by a particular network (e.g., the type of traffic a customer network observes). For example, DNS telemetry data can be used to inform classifications of benign traffic and enable a security service to determine/update a list of websites or domains that are benign, for which traffic classification does not need to be performed at the security service (e.g., by the cloud security platform). The system can update whitelists that are provided (e.g., pushed) to security entities for local enforcement of security policies. DNS telemetry data can thus be used to help reduce the amount of inspection traffic between the security entity and the security service.

However, because DNS telemetry data is deemed as auxiliary or relatively lower priority data, it is important that the DNS telemetry data be filtered or compressed before the security entity sends it to the security service. For example, according to various embodiments, the system does not upload all DNS requests or DNS responses to the security service. Accordingly, the system can report a limited scope of the entire DNS telemetry data collected by the security entity.

The DNS telemetry data reported to the security service can comprise one or more of (i) general information, (ii) response cache hit data, and (iii) NXDomain data. In some embodiments, the system limits the DNS telemetry data to only include the one or more of the general information, response cache hit data, and the NXDomain data. In some embodiments, the system compresses this type of DNS telemetry data to only report certain characteristics of the response cache hit data and the NXDomain data.

The general information may comprise one or more of a window start time, a window end time, and a number of missed packets. The window start time and the window end time may correspond to the respective start and end times for a particular time interval during which DNS telemetry data is cached based on observed DNS traffic (e.g., collected DNS responses) locally (e.g., at the security entity, such as a firewall) a before being reported to a security service (e.g., a cloud security platform). As another example, the window start time and the window end time corresponds to the window of time (e.g., the telemetry window) for a batch of DNS telemetry data being reported to the security service.

According to various embodiments, the response cache hit data comprises one or more of (i) information pertaining to the DNS response resource record (e.g., name, type, and/or IP/domain), (ii) a hit count during the telemetry window, (iii) a first seen timestamp during the telemetry window, (iv) a last seen timestamp during the telemetry window, (v) a category (e.g., a verdict), and (vi) an action taken.

According to various embodiments, the NXDomain data comprises one or more of (i) query data, (ii) a DNS server IP address (e.g., for the DNS server that handled the corresponding DNS query), (iii) a count during the telemetry window (e.g., a number of times the NXDomain response was provided for the corresponding domain during the telemetry window), (iv) a first seen timestamp during the telemetry window, and (v) a last seen timestamp during the telemetry window. The NXDomain data is helpful for administrators of the security service to determine why clients continue to query DNS records for the corresponding domain/website, whether the domain/website is popular, and/or whether the domain may be subject to DNS hijacking.

The system can compress the DNS telemetry data based at least in part on implementing an ADNS telemetry cache. For example, the system uses the ADNS telemetry cache to collect batches of DNS telemetry data for reporting to the cloud service. The batches can be collected during a telemetry window and compressed/filtered over the telemetry window. The use of the ADNS telemetry cache thus allows the bandwidth requirements for sending DNS telemetry data to the security service as compared to a streamlining of DNS telemetry cache.

The ADNS telemetry cache and telemetry window can be configured to optimize the use of the bandwidth between the security entity and the security service (e.g., the cloud security platform). For example, the ADNS telemetry cache and telemetry window can be configured to optimize the

[symbol]

Various embodiments provide a method, system, and computer system for providing advanced domain name system (ADNS) telemetry data. The method includes (i) cache ADNS telemetry data in an ADNS telemetry cache in a local security platform, and (ii) send the cached ADNS telemetry data from the local security platform to a cloud security service in near real time for a real-time threat analysis using ADNS telemetry.

According to various embodiments, the system and process provide a robust solution for managing DNS telemetry data in high-traffic environments, enhancing the ability to monitor network performance, detect security threats, and ensure the integrity of DNS operations.

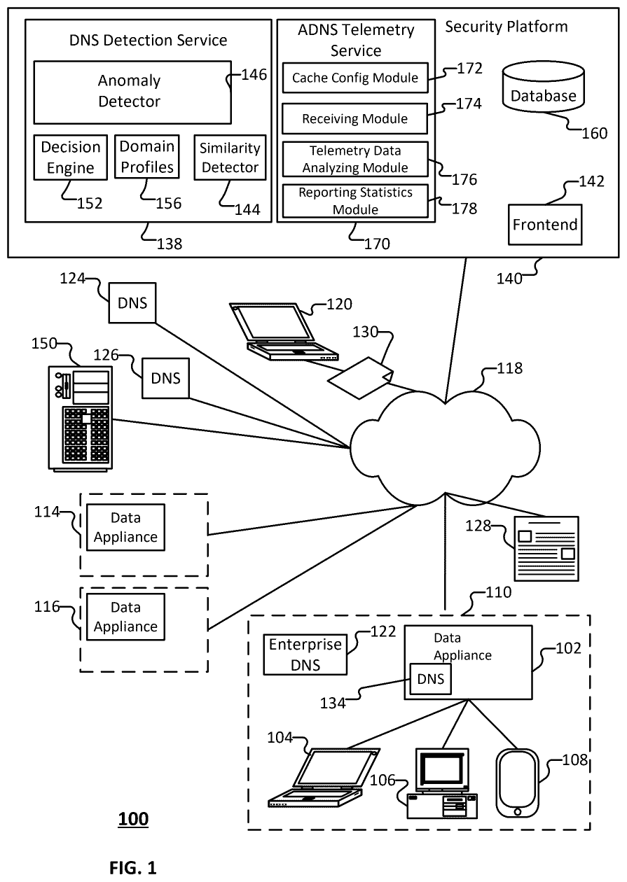

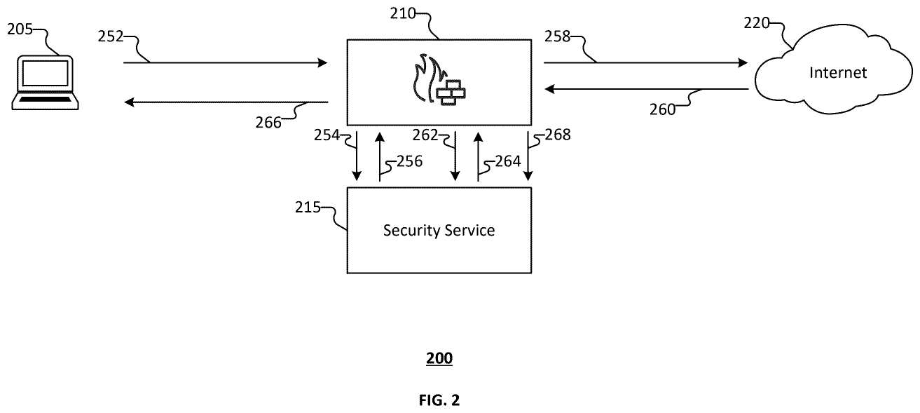

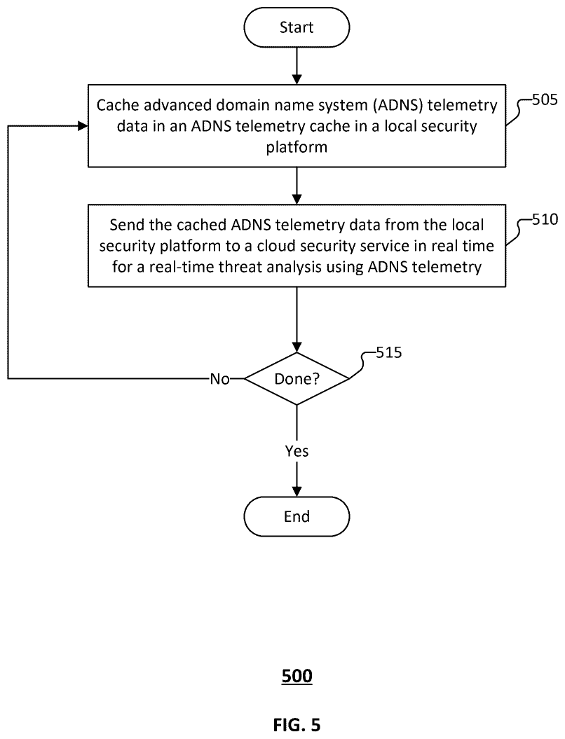

FIG. 1 is a block diagram of an environment for providing a security service to a network according to various embodiments. In various embodiments, system 100 is implemented in connection with one or more of systems 200, 300, and/or 400 of FIGS. 2-4, or one or more of processes 500-1000 of FIGS. 5-10.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android. apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacked record) or benign (e.g., not DNS hijacked), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign). In some embodiments, services provided by security platform 140 additionally comprise simulating DNS hijacking attacks/campaigns (e.g., generating synthetic DNS hijacked records), and/or training classifiers (e.g., training machine learning models, such as to be used to provide detection of DNS hijacked domains).

In some embodiments, security platform 140 classifies the domains in response to receiving a network traffic sample or according to a predefined schedule. In connection with detecting DNS hijacked records, security platform 140 can obtain information pertaining to the domains (e.g., pDNS data, geolocation data, etc.) and classify the DNS records (e.g., the corresponding domains) based at least in part on querying a machine learning model. Security platform 140 may perform periodic polling or monitoring of pDNS data and geolocation data, such as in connection with training a classifier, and/or classifying a set of domains or DNS records. In some embodiments, security platform 140 analyzes or classifies DNS telemetry data to identify exploits or to assist network administrators to improve/optimize the configuration of the system.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32 G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises DNS detection service 138 and/or ADNS telemetry service 170. Security platform 140 may include various other services/modules, such as a malicious file detector, a malicious traffic detector, a parked domain detector, a DNS hijacked domain or DNS record detector, an application classifier or other traffic classifier, etc. DNS detection service 138 is used in connection with analyzing samples of domains and/or automatically detecting DNS hijacked domains. ADNS telemetry service 170 is used in connection with obtaining DNS telemetry data (e.g., reported to security platform 140 from various security entities within the network) and analyzing the received DNS telemetry data.

In some embodiments, ADNS telemetry service 170 comprises one or more of cache config module 172, receiving module 174, telemetry data analyzing module 176, and reporting statistics module 178.

ADNS telemetry service 170 uses cache config module 172 to configure one or more ADNS telemetry caches, such as an ADNS telemetry cache local to a security entity (e.g., an inline firewall). Examples of configurations for the ADNS telemetry cache or the collection and/or reporting of DNS telemetry data include: (a) setting the telemetry window, (b) setting the maximum number of cache entries in the ADNS telemetry cache (e.g., to configure the size of the ADNS telemetry cache or memory allocated for the ADNS telemetry cache), (c) to show/report a counter, (d) to show/report statistics pertaining to the ADNS telemetry cache or the reporting of the DNS telemetry data (e.g., statistics of the number/percentage of ADNS telemetry cache entries that cannot be reported during the telemetry window), (e) to provide (e.g., print, display, etc.) a debug log, (f) to stop/start the writing of entries to the ADNS telemetry cache (e.g., to stop/start the caching of DNS telemetry data), (g) to stop/start the reporting (e.g., uploading) of DNS telemetry data to the cloud security platform, (h) to debug or print the current ADNS telemetry cache, (i) to clear the ADNS telemetry cache, and/or (j) to clear statistics pertaining to the ADNS telemetry cache. In some embodiments, the configuration interface enables the system (e.g., a user via a client system) to query the ADNS telemetry cache, such as to identify information for a particular domain.

ADNS telemetry service 170 uses receiving module 174 to receive DNS telemetry data reported to security platform 140 by an ADNS telemetry data cache. For example, receiving module is configured to receive the DNS telemetry data from a security entity such as an inline firewall (e.g., a next generation firewall).

ADNS telemetry service 170 uses telemetry data analyzing module 176 that is configured to analyze received DNS telemetry data. In some embodiments, security platform 140 can identify DNS exploits based at least in part on the analysis of the DNS telemetry data. Additionally, or alternatively, ADNS telemetry service 170 can determine to configure an ADNS telemetry cache based at least in part on the analysis of the DNS telemetry data.

ADNS telemetry service 170 uses reporting statistics module 178 to obtain statistics information associated with the DNS telemetry data and/or an ADNS telemetry cache. For example, reporting statistics module 178 obtains information pertaining to the statistics for the reporting of DNS telemetry data by the ADNS telemetry cache Examples of statistics information includes: (a) a utilization of the ADNS telemetry cache (e.g., an indication of whether the entries to be logged to the ADNS telemetry cache during a telemetry window exceeds the available entry capacity, and the extent to which the demand to log an entry exceeds or is less than the ADNS telemetry cache entry capacity), (b) an indication of a number of entries in the ADNS telemetry cache that were not reported to the security platform 140 (e.g., because the bandwidth was insufficient to transfer the total number of entries in the ADNS telemetry cache during the telemetry window), etc.

In some embodiments, DNS detection service 138 detects/classifies a domain. For example, DNS detection service 138 predicts whether a particular DNS record (e.g., a candidate domain) is a DNS hijacked record (e.g., whether the candidate domain is a DNS hijacked domain). Alternatively, DNS detection service 138 can predict whether a particular domain is a DNS hijacked domain (e.g., is associated with a DNS hijacked record). In some embodiments, DNS detection service 138 classifies the domain or DNS record based at least in part on a signature of the candidate domain or DNS record, such as by querying a mapping of signatures to domain or DNS record identifiers (e.g., a set of previously analyzed/classified domains or DNS records). As an example, DNS detection service 138 uses a signature or domain or DNS record identifier to query a blacklist of domains to check whether the candidate domain or DNS record is on the blacklist of domains. In some embodiments, DNS detection service 138 classifies the domain or DNS record based on a predicted domain or DNS record classification (e.g., a prediction of whether a candidate DNS record is a DNS hijacked record, whether the candidate record is not a DS hijacked record, or whether a candidate domain is malicious or benign, etc.). For example, DNS detection service 138 determines (e.g., predicts) the domain classification based at least in part on domain or DNS record data for the candidate domain or DNS record. Examples of domain or DNS record data include a certificate information pertaining to a certificate(s) associated with the candidate domain (e.g., the domain associated with the particular DNS request), registration information, pDNS data, geolocation data, scan data, active DNS information, zone file information, WHOIS registry data, web crawled data (e.g., data obtained by crawling the website), etc.

In some embodiments, DNS detection service 138 determines a domain or DNS record classification for a candidate domain or DNS record based at least in part on a machine learning-based classification. As an example, DNS detection service 138 (e.g., decision engine 152) uses a machine learning-based classifier to determine a prediction of whether the candidate DNS record is a DNS hijacked record. Additionally, or alternatively, DNS detection service 138 (e.g., similarity detector 144 or domain profiles 156) may implement one or more of a fingerprinting-based classification, a heuristics-based classification, or other rule-based classification to classify the candidate domain or DNS record. For example, DNS detection service 138 performs a post-filtering with respect to the predictions generated by the machine learning-based classifier. The post-filtering can be performed using a fingerprinting-based classifier, a heuristics-based classifier, and/or other rule-based classifier to filter out potential false positives generated by the machine learning-based classifier (e.g., to remove predicted candidate DNS records that are likely not DNS hijacked domains).

In some embodiments, DNS detection service 138 (e.g., anomaly detector 146 or decision engine 152) includes a model (e.g., a machine learning model) that is trained to detect DNS hijacked domains or DNS hijacked attacks/campaigns. In some embodiments, DNS detection service 138 is trained to detect DNS hijacked records. In response to determining a predicted classification for a domain or DNS records (e.g., a candidate domain or candidate DNS record), DNS detection service 138 may determine a signature for the domain or DNS record and store the signature in a mapping of signatures to domains or DNS record classifications (e.g., an indication of whether the candidate domain or DNS record is malicious/DNS hijacked or benign/non-DNS hijacked) the domain or DNS record signature in association with the predicted classification.

In some embodiments, system 100 (e.g., security platform 140, such as via DNS detection service 138 or more particularly, anomaly detector 146 or decision engine 152, etc.) trains a classifier (e.g., a model) to detect (e.g., predict) DNS hijacked records (e.g., to predict a DNS record classification for a particular DNS record, such as DNS records intercepted by an inline security entity). The classifier is trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), etc. In some embodiments, DNS detection service 138 implements a random forest model.

According to various embodiments, in response to DNS detection service 138 (e.g., anomaly detector 145 or decision engine 152) classifying the candidate record, system 100 handles the traffic to/from the candidate domain according to a predefined policy (e.g., a security policy). For example, the system queries a traffic handling policy to determine the manner by which traffic to/from a domain matching the candidate domain is to be handled. The traffic handling policy may be a predefined policy, such as a security policy, etc. The traffic handling policy may indicate that traffic to/from certain domains is to be blocked and traffic to/from other domains is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed candidate record, security platform 140 (e.g., DNS detection service 138) sends an indication that records matching the candidate record are associated with, or otherwise correspond to, the determined classification. In the case that the determined classification for the candidate record is that the candidate record is a DNS hijacked record, security platform 140 provides an indication that traffic to/from a domain matching the candidate domain (e.g., the same domain signature or same originating IP address, etc.) is also to be handled according to whether the candidate domain is a DNS hijacked record. Security platform 140 can provide an indication that DNS requests and DNS responses corresponding to the candidate record predicted to be handled as a DNS hijacked record. For example, security platform 140 (e.g., DNS detection service 138) determines (e.g., computes) a signature or identifier for the domain or DNS record for the candidate record (e.g., a hash or other signature), and sends to a network node (e.g., a security entity, an endpoint such as a client device, etc.) an indication of the classification associated with the signature (e.g., an indication whether the record is a DNS hijacked record, or an indication of whether the domain is a malicious/non-malicious domain, or an indication of whether traffic to/from the domain is malicious traffic). Security platform 140 may update a mapping of signatures to domain or DNS record classifications and provide the updated mapping to the security entity. In some embodiments, security platform 140 further provides to the network node (e.g., security entity, client device, etc.) an indication of a manner by which traffic to a domain or DNS record matching the signature is to be handled. For example, security platform 140 provides to the security entity a traffic handling policy, a security policy, or an update to a policy.

In some embodiments, system 100 (e.g., DNS detection service 138 of security platform 140, or other security entity, etc.) determines whether information pertaining to a particular candidate record (e.g., a newly received candidate record to be analyzed) is comprised in a dataset of historical domains (e.g., historical network traffic, previously classified domains), whether a particular signature is associated with malicious traffic, or whether traffic corresponding to the candidate record to be otherwise handled in a manner different than the normal traffic handling. The historical information may be provided by another system or module, such as a service running on security platform 140, or by a third-party service such as VirusTotal™, or both. In response to determining that information pertaining to a candidate record (or corresponding domain) is not comprised in, or available in, the dataset of historical domains (e.g., historical or previously analyzed domains), system 100 (e.g., DNS detection service 138 or other security entity) may deem that the domain/traffic has not yet been analyzed and system 100 can invoke an analysis (e.g., a domain analysis) of the candidate record (e.g., an analysis of the domain or DNS record data for the candidate record) in connection with determining (e.g., predicting) the record (e.g., DNS record)classification. The historical information (e.g., from a third-party service, a community-based score, etc.) indicates whether other vendors or cyber security organizations deem the particular traffic as malicious or should be handled in a certain manner.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains that are scams, phishing sites, or sites used to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

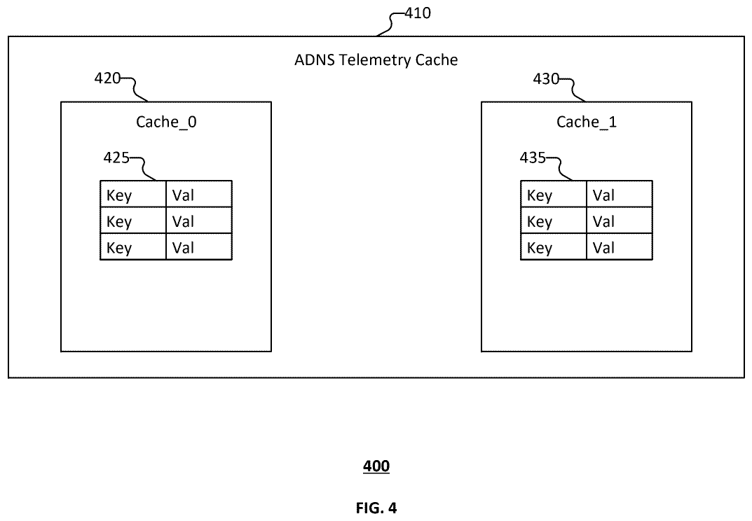

FIG. 2 is a block diagram of a system to handle DNS requests and DNS responses according to various embodiments. In some embodiments, system 200 implements at least part of system 100 of FIG. 1. In some embodiments, system 200 is implemented at least in part by system 300 of FIG. 4. System 200 can implement one or more of processes 500-1000 of FIGS. 5-10.

System 200 is configured to provide a security service for a client system, such as client system 205, or a network with which the client system is associated (e.g., a security service customer's enterprise network). According to various embodiments, system 200 is configured to provide DNS record classifications and to collect DNS telemetry data for analysis. System 200 may report (e.g., send) the DNS telemetry data to a security service (e.g., a cloud security platform).

In the example shown, system 200 comprises one or more of a client system 205, a security entity (e.g., firewall 210), and/or security service 215.

System 200 comprises a detection pipeline that can detect malicious traffic, such as by classifying internet or application traffic, files transmitted across (e.g., to/from) the network, or DNS traffic. System 200 can use a security entity, such as firewall 210, to provide inline detection. For example, firewall 210 can intercept network traffic and perform an inline classification, such as by using a light weight classifier (e.g., a machine learning model) or by comparing an identifier for the traffic (e.g., a hash computed for the traffic such as a hash of the file, a hash of the header, etc.) to a whitelist or blacklist provided to the firewall 210 by security service 215. Firewall 210 can also provide a real-time detection by querying security service 215 to provide a classification for the network traffic (e.g., the file, internet or application traffic, or DNS traffic). In connection with providing the real-time detection, firewall 210 queries the security service 215 contemporaneous with the handing of the traffic being classified. For example, firewall 210 can query the security service 215 and receive a response (e.g., the classification) within 100 ms of firewall 210 intercepting the traffic.

The following description of system 200 is provided in the context of DNS traffic and system 200 providing security service with respect to DNS traffic.

As an illustrative example, system 200 uses an offline detection pipeline to perform DNS record classification offline and store the DNS classifications in a dataset, for example, a set of detected DNS hijacked records. The DNS hijacked records can be stored in a dataset that can be queried for future classifications, or can be used to generate a whitelist and/or blacklist of DNS records or domains that can be used for a lightweight/quick detection, such as inline by firewall 210. Security service 215, or another offline detection pipeline used to populate a dataset of DNS hijacked records, collects records (e.g., via interception of DNS traffic, such as by firewall 210) that were observed over a predetermined time period (e.g., one day) and the DNS records are processed offline to determine the corresponding DNS record classifications. The predetermined period of time over which records are collected is typically 1 day or longer. For example, the predetermined period of time is generally a period that does not lend itself to real-time DNS record detection. During processing of the collected DNS records (e.g., the DNS records observed over the previous day), the offline detection pipeline obtains data to be used for the DNS record classifications (e.g., pDNS data, geolocation data, subnet history data) and pre-computes data to be used in the DNS record classifications. For example, all features to be used by a classifier in the DNS record classification are computed during the processing of the collected DNS records. The offline detection pipeline stores the detected hijacking records in a datastore, such as a datastore comprising the dataset of DNS hijacked records dataset. The dataset of DNS hijacked records dataset 225 is then used later by firewall 210 (e.g., via security service 215) to block DNS responses inline that contain DNS hijacking records.

At 252, firewall 210 obtains a DNS request from a client system 205 (e.g., a customer's systems). Firewall 210 may intercept the DNS request during the handling or mediating traffic to/from the client system 205. In response to obtaining the DNS request, firewall 210 sends the DNS request to security service 215, such as in connection with querying security service 215 for an indication of whether the DNS request is to be allowed. Security service 215 can determine whether the DNS request is to be allowed, such as based on querying an allow list or a historical dataset of classified domains or records (e.g., DNS hijacked records dataset 225). If security service 215 determines that the DNS request is to be allowed, at 256, security service 215 provides to firewall 210 an indication that the DNS request is allowed (otherwise, security service 215 can provide an indication that the DNS request is to be disallowed). In response to receiving an indication that the DNS request is not to be allowed (e.g., is to be disallowed), firewall 210 can correspondingly apply a security policy with respect to the DNS request, such as to block or quarantine the DNS request. Conversely, in response to receiving an indication that the DNS request is to be allowed, at 258, firewall 210 queries a DNS service 220 (e.g., a third party service) for a DNS response (e.g., for the information to resolve the domain comprised in the DNS request). At 260, firewall 210 obtains the DNS response from DNS service 220. Before providing the DNS response to client system 205, firewall 210 can query security service 215 for an indication of whether the DNS response is to be allowed. At 262, firewall 210 provides the DNS response to security service 215. In response to receiving the DNS response, security service 215 can query a dataset of precomputed classifications (e.g., DNS record classifications processed offline, such as classifications as most recent as the previous day). Security service 215 determines whether the DNS response should be allowed or disallowed based on the historical classifications (e.g., the data set of DNS hijacked records). In response to determining that the DNS response is to be disallowed (e.g., based on determining that the record was previously classified as a DNS hijacked record), security service 215 can provide an indication to firewall 210 that DNS response is to be disallowed and firewall 210 correspondingly applies a security policy, such as to block or quarantine the DNS response. In response to determining that the DNS response is to be allowed, at 264, security service 215 provides to firewall 210 the indication that the DNS request is to be allowed. In response to firewall 210 receiving an indication that the DNS response is allowed (e.g., that the corresponding record is not a DNS hijacked record), at 266, firewall 210 provides the DNS response to client system 205.

According to various embodiments, the security entity stores (e.g., caches) DNS telemetry data pertaining to the observed (e.g., the intercepted) DNS traffic. In some embodiments, a security entity (e.g., firewall 210) comprises an ADNS telemetry cache that is configured to store DNS telemetry data. For example, firewall 210 stores DNS telemetry data associated with each DNS traffic transaction (e.g., a DNS query and corresponding DNS response). Because of bandwidth constraints between a security entity (e.g., firewall 210) and the cloud security platform (e.g., security service 215), the DNS telemetry data can be cached and transmitted after predefined time intervals (e.g., telemetry windows). The cached DNS telemetry data can be filtered or compressed to further limit the amount of DNS telemetry data sent from the security entity to the cloud security platform.

The collected DNS telemetry data is filtered so response cache hit data and NXDomain data is sent to the cloud security platform. In some embodiments, the security entity filters the collected DNS telemetry data so that only general information, the response cache hit data, and the NXDomain data is sent to the cloud security platform. Additionally, or alternatively, this DNS telemetry data (e.g., the filtered DNS telemetry data) can be compressed by deduplicating records for the same domain, IP address, or DNS record. For example, if the security entity observes a plurality of NXDomain responses for a particular domain within a telemetry window, instead of recording an entry for each observed NXDomain record, the security entity maintains a single entry (e.g., record) associated with the NXDomain data for the particular domain, and updates the entry to update a count associated with the number of observations of that particular NXDomain response within the telemetry window.

According to various embodiments, system 200 (e.g., an inline security entity) caches the DNS telemetry data in the ADNS telemetry cache according to a predefined cycle time that is based on a telemetry window. The telemetry window is a predefined particular time interval during which: (a) collected (e.g., observed) DNS telemetry data is cached in an active part of the ADNS telemetry cache, and (b) cached DNS telemetry data that is stored in the inactive part of the ADNS telemetry cache is sent to the cloud security platform (e.g., security service 215). In some embodiments, at the end of a telemetry window, the system (e.g., firewall 210) toggles the then-inactive part of the ADNS telemetry cache to be activated, and toggles the then-active part of the ADNS telemetry cache to be inactivated. In some embodiments, the telemetry window is configured to optimize the transmission of DNS telemetry data or to ensure that the telemetry window is generally long enough for all entries in the then-inactive part of the ADNS telemetry cache to be transmitted. According to various embodiments, the telemetry window is 1 second. In some embodiments, the telemetry window (e.g., the particular time interval) is less than or equal to 5 seconds. However, the telemetry window is configurable and various other lengths of time can be implemented.

In the example shown, at 268, firewall 210 transmits cached DNS telemetry data to security service 215. For example, during a current telemetry window (e.g., a particular time interval) firewall 210 transmits cached DNS telemetry data in the then-inactive part of the ADNS telemetry cache (e.g., the DNS telemetry data that had been cached in the preceding telemetry window). The cached DNS telemetry data can be transmitted according to a protocol that minimizes/reduces data loss. Examples of transfer protocols include TCP, ICMP, etc. various other transfer protocols may be implemented.

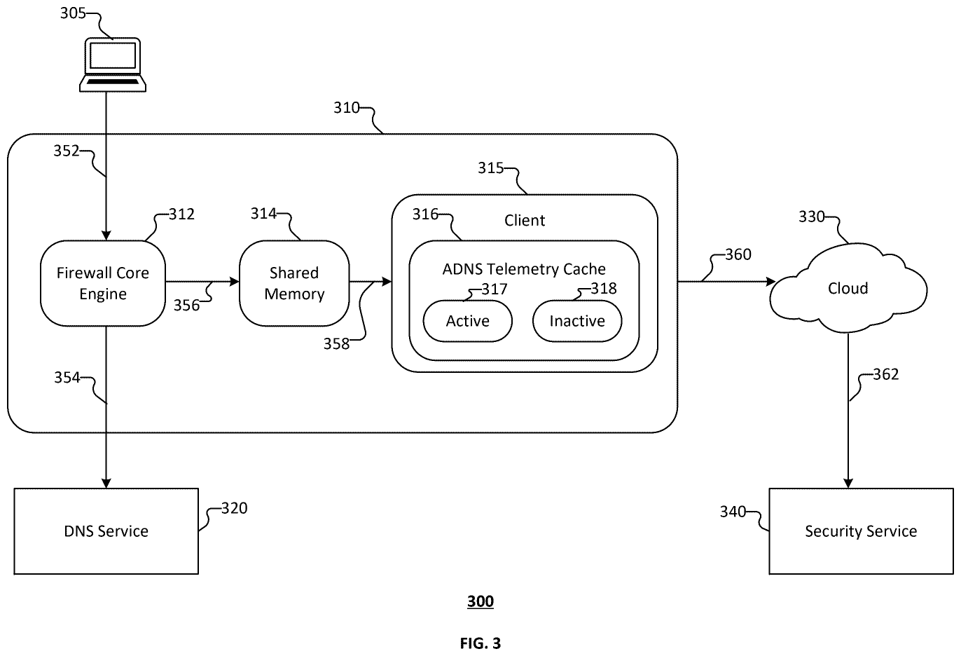

FIG. 3 is an illustration of a system for caching and reporting DNS telemetry data according to various embodiments. In some embodiments, system 300 implements at least part of system 100 of FIG. 1 and/or system 200 of FIG. 2. In some embodiments, system 300 is implemented at least in part by FIG. 4. System 300 can implement one or more of processes 500-1000 of FIGS. 5-10.

System 300 is configured to provide a security service for a client system, such as client system 305, or a network with which the client system is associated (e.g., a security service customer's enterprise network). According to various embodiments, system 300 is configured to provide DNS record classifications and to collect DNS telemetry data for analysis. System 300 may report (e.g., send) the DNS telemetry data to a security service (e.g., a cloud security platform).

In the example shown, system 300 comprises firewall 310. System 300 may additionally comprise, or interface with, client system 205, DNS service 320, and/or a security service 340 (e.g., via cloud 330). According to various embodiments, firewall 310 comprises ADNS telemetry cache 316. System 300 (e.g., firewall 310) uses ADNS telemetry cache 316 to cache DNS telemetry data collected (e.g., observed) by firewall 310, such as based at least in part on intercepted DNS traffic.

According to various embodiments, the ADNS telemetry cache 316 comprises a first cache (e.g., cache_0) and a second cache (e.g., cache_1). At any given time, either of these two caches is active while the other cache is inactive. In the example shown, these active and inactive caches are respectively denoted by active cache 317 and inactive cache 318. The system can toggle the active/inactive state of the caches according to a cycle time that is based on a predefined telemetry window(s), which may be configurable (e.g., by an administrator).

Upon expiration of a telemetry window (e.g., the predefined particular time interval), firewall 310 toggles active cache 317 to be inactive and toggles the inactive cache 318 to active. During the telemetry window during the part of the cache is inactive, firewall 310 sends the DNS telemetry data stored in such part of the cache to security service 340, such as via cloud 330.

According to various embodiments, the active DNS telemetry cache (e.g., active cache 317) is being actively written (e.g., during a particular telemetry window) by the live DNS response handling process.

According to various embodiments, the inactive DNS telemetry cache (e.g., inactive cache 318) is the previous active DNS telemetry cache (e.g., the active cache in the during the previous telemetry window) containing valid data. The system can forward the content of the inactive DNS telemetry cache slowly and steadily to the cloud security service during the current telemetry window. This configuration enables avoidance of a sudden burst of traffic that floods the memory (e.g., the shared memory 314) and caused undesired QoS actions.

In some embodiments, firewall 310 additionally comprises one or more of firewall core engine 312 and shared memory 314.

At 352, firewall 310 obtains a DNS request from a client system 305 (e.g., a customer's systems). Firewall 310 may intercept the DNS request during the handling or mediating traffic to/from the client system 305. For example, firewall core engine 312 intercepts the DNS traffic (e.g., a DNS query) from client system 305 to DNS service 320.

In response to obtaining (e.g., intercepting) the DNS request, at 354, firewall 310 (e.g., via firewall core engine 312) queries a DNS service 320 (e.g., a third party service) for a DNS response (e.g., for the information to resolve the domain comprised in the DNS request). Firewall 310 further obtains the DNS response from DNS service 320.

At 356, as firewall 310 (e.g., firewall core engine 312) mediates NDS traffic between client system 304 and DNS service 320, firewall 310 stores information associated with the DNS traffic in shared memory 314. In some embodiments, firewall 310 stores DNS telemetry data, such as the response cache hit data, and the NXDomain data.

In some embodiments, the sending the cached ADNS telemetry data to the cloud security service comprises: (a) communicate, during a particular time interval (e.g., a current telemetry window), to the cloud service DNS telemetry data stored in the inactive cache; (b) store, during a particular time interval (e.g., a current telemetry window), DNS telemetry information in the active cache in response to the ADNS local cache being queried and hit during the particular time interval. The ADNS local cache should be queried by each DNS response. However, not every one of the DNS responses find a hit in the ADNS local cache. When there is a “miss”, the ADNS telemetry cache does not get updated.

According to various embodiments, each ADNS local cache hit and each DNS response packet carrying NXDomain code generate a local ADNS telemetry message that is provided to shared memory 314 and/or ADNS telemetry cache 316. In the case of an ADNS local cache hit, the ADNS telemetry message comprises the rrname, rrtype, rrdata, an indication of the verdict (e.g., whether the DNS record is hijacked, or whether the DNS traffic is malicious, etc.), and an indication of the action (e.g., an indication that the DNS response was blocked, dropped, permitted to pass to the client system 305, etc.). In the case of an NXDomain response, the ADNS telemetry message comprises an indication of the domain and an indication of the server IP address (e.g., an indication of the particular DNS server that processed the DNS request). Knowledge of the server IP address is important because DNS servers can have different databases and thus a DNS record may be found for a particular domain in a first DNS server database but not in a second DNS database.

At 358, ADNS telemetry cache 316 obtains the DNS telemetry data from shared memory 314. For example, ADNS telemetry cache 316 can retrieve (e.g., via client 315) the DNS telemetry data from shared memory 314 and store the DNS telemetry data in ADNS telemetry cache 316 (e.g., in active cache 317). In some embodiments, client 315 can obtain information associated with the DNS traffic for various purposes, such as to determine a manner for handling the DNS traffic, classifying the DNS traffic, querying security service 340 for a DNS traffic classification (e.g., a predicted classification for a DNS response), reporting DNS telemetry data to security service 340, etc.

At 360, firewall 310 (e.g., ADNS telemetry cache 316, such as via client 315) sends the DNS telemetry cache to security service 340 via cloud 330 (e.g., the internet). For example, security service 340 is a cloud security platform.

According to various embodiments, in response to expiration of the particular time interval, provide to a cloud security service information determined based at least in part on the entries in the inactive cache that were not successfully communicated to the cloud security service during the particular time interval. In some embodiments, DNS telemetry data not being able to be sent to the cloud during the past telemetry window, may be sent in the later telemetry windows. In some embodiments, the system discards any DNS telemetry data that is not written into the ADNS telemetry cache in case the active cache is full. Additionally, or alternatively, the system discards any DNS telemetry data that is not forwarded to the cloud security platform during the corresponding telemetry window (e.g., the particular telemetry window during which the entries in the inactive cache are reported to the cloud security service).

According to various embodiments, the system comprises a configuration interface via which the ADNS telemetry cache or the collection and/or reporting of DNS telemetry data can be configured. Examples of configurations for the ADNS telemetry cache or the collection and/or reporting of DNS telemetry data include: (a) setting the telemetry window, (b) setting the maximum number of cache entries in the ADNS telemetry cache (e.g., to configure the size of the ADNS telemetry cache or memory allocated for the ADNS telemetry cache), (c) to show/report a counter, (d) to show/report statistics pertaining to the ADNS telemetry cache or the reporting of the DNS telemetry data (e.g., statistics of the number/percentage of ADNS telemetry cache entries that cannot be reported during the telemetry window), (e) to provide (e.g., print, display, etc.) a debug log, (f) to stop/start the writing of entries to the ADNS telemetry cache (e.g., to stop/start the caching of DNS telemetry data), (g) to stop/start the reporting (e.g., uploading) of DNS telemetry data to the cloud security platform, (h) to debug or print the current ADNS telemetry cache, (i) to clear the ADNS telemetry cache, and/or (j) to clear statistics pertaining to the ADNS telemetry cache. In some embodiments, the configuration interface enables the system (e.g., a user via a client system) to query the ADNS telemetry cache, such as to identify information for a particular domain.

FIG. 4 is an illustration of an advance domain name system (ADNS) telemetry cache according to various embodiments. System 400 may be implemented by system 100 of FIG. 1, system 200 of FIG. 2, and/or system 300 of FIG. 3.

In some embodiments, the ADNS telemetry cache is configured based on a quantified DNS telemetry data volume that is expected to be uploaded to the cloud security platform (e.g., security service 340 of system 300). For example, the cache structure, sizing, and algorithm to be implemented by ADNS telemetry cache is configured based the DNS telemetry data expected to be sent to the cloud security platform. Additionally, the telemetry window can be configured based on the DNS telemetry data expected to be sent to the cloud security platform.

According to various embodiments, an advance domain name system (ADNS) service queries the cloud security platform with respect to information that is used to detect a DNS hijacking and/or a DNS misconfiguration. As an example, DNS hijacking includes the interception of the DNS response packets or taking over a DNS server, which enables the attackers to present the false information in the RR to the DNS client. For instance, a DNS client may look for [abc.org, IPv4, 1.2.3.4] while the attacker tampers the RR to [abc.org, IPv4, 2.3.4.5] to direct the client to a malicious IP address. As another example, DNS misconfiguration includes a DNS record stored in the DNS server containing false information. For instance, an organization may register a domain for a short-term event while leaving the domain unmaintained after a while. An attacker may take over the domain and use it for malicious purposes.

The firewall or ADNS service (e.g., implemented by the firewall) generally does not upload all the DNS response data to the cloud security platform (e.g., as part of the inquiry traffic). For example, the firewall or ADNS service does not provide (e.g., as part of the inquiry traffic) to the cloud security platform DNS responses that hit the firewall local cache or DNS responses that carry an NXDomain code. According to various embodiments, the ADNS telemetry cache 316 provides condensed information of the NXDomain and local cache hit to the cloud for real-time threat analysis.

Generally, a firewall or ADNS service support 20,000 DNS responses per second, which is approximately equivalent to 47.55 Mbps of bandwidth. Based on empirical analysis, the ADNS local cache hit rate is estimated to be around 53%, which is approximately equivalent to a 15.72 Mbps transfer bandwidth. In some implementations, the firewall only has the capability to upload 34 Mps to the cloud.

According to various embodiments, traffic throughput of the DNS telemetry cache data being reported to the cloud security platform is limited to around 1 to 2 Mbps, if 50% of the upload bandwidth (e.g., 50% of 34 Mps) is allocated to ADNS service.

Empirical analysis shows that DNS response traffic is generally Zipf-distributed. As such most of the requested domains correspond to the top few websites. Specifically, assuming a hit rate of the top domain=x, the second top domain's hit rate is x/2, the third top domain's hit rate is (x/2)/2=x/4, and so on.

Because the DNS traffic is Zipf-distributed, the first few popular websites will be the dominant component of DNS traffic. Accordingly, the ADNS telemetry cache of various embodiments only needs to be relatively small to cover the multiple cases. According to various embodiments, the ADNS telemetry caches stores at most one record for each domain. For example, if multiple DNS queries/responses for a particular domain are intercepted during the telemetry window, the system stores one entry for the particular domain. The entry for the particular domain may include information based on the multiple DNS queries/responses for a particular domain. As an example, the entry for the particular domain includes count information indicating a number of responses for such domain during the telemetry window. In some embodiments, the ADNS telemetry cache is 10 MB.

Based on simulation data, a 10240-entry ADNS telemetry cache is expected to be sufficient to store the DNS telemetry data pertaining to the response cache hit data and the NXDomain data. However, the size of the ADNS telemetry cache is configurable. For example, the maximum number of cache entries may be configurable based on the system configuration, DNS traffic profile, etc. If the system has a large enough ADNS telemetry cache, the system can send out the DNS telemetry data periodically with a minimum (e.g., or relatively low) possibility to lose records due to cache overflow. Some simulation results show that a 5 MB ADNS telemetry cache where the system is configured to implement a 1 second telemetry window is good enough to cover high-volume DNS response traffic.

Each cache entry's memory usage is variable depending on how long the actual “key” string is. As an example, in the worst case scenario, a max rrname consumes 253 bytes and a max rrdata consumes another 253 bytes. Together the whole string consumes 506 bytes plus 3 bytes to record the rrtype, verdict, and action. In the practical situation, various embodiments assume that the average row size is less than 512 bytes. 10240 entries times 512 bytes is 5 MB (10240*512/1024/1024=5). So, the active and inactive ADNS telemetry cache consumes less than 5 MB+5 MB=10 MB. In some embodiments, the process (e.g., client 315) that maintains the ADNS telemetry cache has a minimum memory allocation of 500 MB. Accordingly, a next generation firewall can be configured with sufficient space to store the total 10240*2=20480 entries of the active and inactive ADNS telemetry caches.

In case that the ADNS telemetry cache counters indicate that DNS Telemetry data is dropped (e.g., that DNS telemetry data is not reported for all entries currently in the ADNS telemetry cache during a particular telemetry window) because the 10240 entries of the active ADNS telemetry cache are fully occupied, a user can configure the ADNS telemetry cache to change 10240 (e.g., the maximum number of entries) to a larger value to accommodate more ADNS telemetry data. The user can also reduce the “time interval” from 1 second to a lower value, e.g., 500 millisecond, to upload and flush the inactive ADNS telemetry cache more frequently. As an example, the granularity with which the “time interval” can be changed is millisecond.

The simulations of DNS traffic, caching DNS telemetry data, and reporting the DNS telemetry data to the cloud security platform indicates that each second 40.28% of the 10240 entries in the ADNS telemetry cache are occupied in average, assuming that there is a 10 MB local DNS response cache. This 40.28% of the 10-24 entry ADNS telemetry cache is roughly equivalent to equivalent to 1 Mbps, if the firewall or ADNS service uploads the NXDomain query FQDNs and {rrname+rrtype+rrdata} of the local cache hit to the cloud.

According to various embodiments, the ADNS telemetry cache comprises a plurality of caches. Various ones of the plurality of caches can be active or inactivated during a particular telemetry window. In the example shown, ADNS telemetry cache 410 comprises two caches: first cache 420 (e.g., cache_0) and a second cache 430 (e.g., cache_1).

The caches in the ADNS telemetry cache 410 are configured to store response cache hit data and NXDomain data. For example, the response cache hit data and NXDomain data can be stored in the same dataset (e.g., table) with different identifiers. In some embodiments, ADNS telemetry cache 410 (e.g., first cache 420 and/or second cache 430) store entries for the DNS telemetry data as key-value pairs. In such an implementation, entries for response cache hit data and NXDomain data can be stored in the same table with different keys.

According to various embodiments, the DNS telemetry data entries are stored in key-value pairs. In some embodiments, the key is a string.

In some embodiments, in the case of an NXDomain response, the key is a concatenation based at least in part on the domain and the server IP address. For example, the key is a concatenated string of {domain, server IP address). As an illustrative example, a row/entry can be: “{nonexist.website, 1.1.1.1}”. The concatenated string can be generated according to a predefined process/syntax. Various different concatenation techniques or syntax can be implemented. The values for an entry include one or more of: a hit count during the active window; a first-seen timestamp during the current active window; and a last-seen timestamp during the current active window. In some embodiments, the values for an entry include each of the hit count during the active window; the first-seen timestamp during the current active window; and the last-seen timestamp during the current active window.

In some embodiments, in the case of an ADNS local cache hit, the key is a concatenation based at least in part on the rrname, rrtype, rrdata, verdict, and action. For example, the key is a concatenated string of {rrname, rrtype, rrdata, verdict, and action} . As an illustrative example, a row/entry can be: “{google.com, ipv4, 8.8.8.8, benign, allow}”. The concatenated string can be generated according to a predefined process/syntax. Various different concatenation techniques or syntax can be implemented. The values for an entry include one or more of: a hit count during the active window; a first-seen timestamp during the current active window; and a last-seen timestamp during the current active window. In some embodiments, the values for an entry include each of the hit count during the active window; the first-seen timestamp during the current active window; and the last-seen timestamp during the current active window.

FIG. 5 is a flow diagram of a method for providing DNS telemetry data according to various embodiments. In some embodiments, process 500 is implemented at least in part by system 100 of FIG. 1, system 200 of FIG. 2, and/or system 300 of FIG. 3. Process 500 may be implemented by a system providing security service to an inline security entity, such as to a firewall (e.g., a next generation firewall).

At 505, the system caches advanced domain name system (ADNS) telemetry data in an ADNS telemetry cache in a local security platform. For example, the system intercepts DNS traffic, identifies DNS telemetry data based at least in part on the DNS traffic, and caches the DNS telemetry data in an ADNS telemetry cache. The system can identify DNS telemetry data that is observed (e.g., collected) during a particular time interval (e.g., during a particular telemetry window). At 510, the system sends the cached ADNS telemetry data from the local security platform to a cloud security service in real-time for a real-time threat analysis using ADNS telemetry. The system can send the DNS telemetry data stored in the ADNS telemetry cache after the telemetry window during which the DNS telemetry data was collected (e.g., the DNS telemetry data is sent to a cloud security platform during the subsequent telemetry window). At 515, a determination is made as to whether process 500 is complete. In some embodiments, process 500 is determined to be complete in response to a determination that no further DNS telemetry data is to be cached, no further DNS records are obtained, no further DNS telemetry cache entries are to be reported/sent to a cloud security service, an administrator indicates that process 500 is to be paused or stopped, etc. In response to a determination that process 500 is complete, process 500 ends. In response to a determination that process 500 is not complete, process 500 returns to 505.

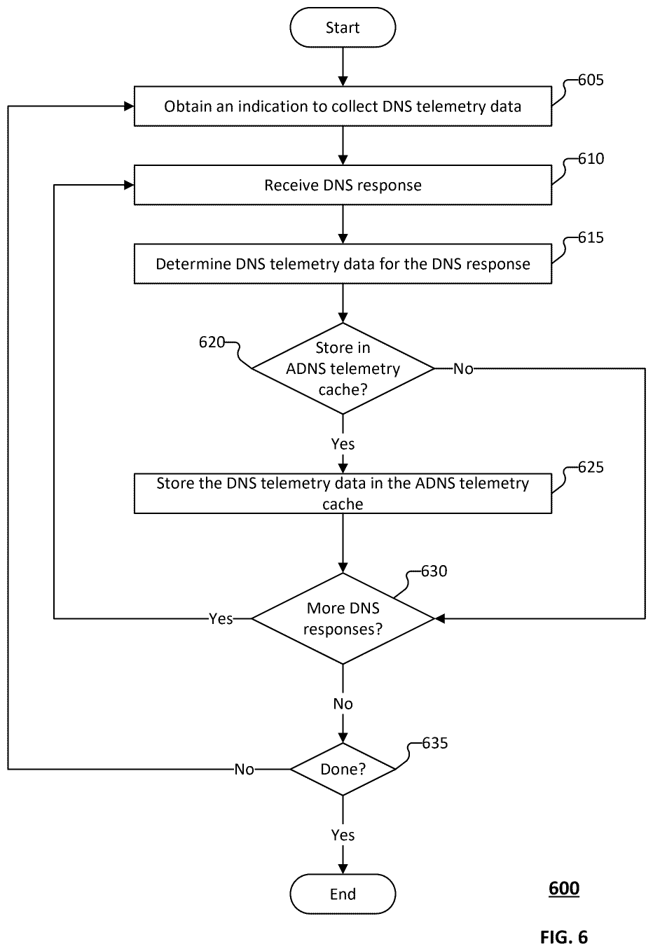

FIG. 6 is a flow diagram of a method for storing DNS telemetry data in an ADNS telemetry cache according to various embodiments. In some embodiments, process 600 is implemented at least in part by system 100 of FIG. 1, system 200 of FIG. 2, and/or system 300 of FIG. 3. Process 600 may be implemented by a system providing security service to an inline security entity, such as to a firewall (e.g., a next generation firewall).

At 605, the system obtains an indication to collect DNS telemetry data. At 610, the system receives a DNS response. For example, the system intercepts the DNS response before it is returned to a client system, such as the system from which a corresponding DNS request originated. At 615, the system determines DNS telemetry data for the DNS response. At 620, the system determines whether to store the DNS telemetry data in an ADNS telemetry cache. In some embodiments, the determining whether to store the DNS telemetry data in the ADNS telemetry cache comprises invoking process 700. The system can determine to store the DNS telemetry data in the ADNS telemetry window based on a determination of whether the DNS telemetry data is an NXDomain response, an ADNS local cache hit, etc. In response to determining that the DNS telemetry data is not to be stored in the ADNS telemetry cache, process 600 proceeds to 630. Conversely, in response to determining that the DNS telemetry data is to be stored in the ADNS telemetry cache, process 600 proceeds to 620. At 625, the system stores the DNS telemetry data in the ADNS telemetry cache. In some embodiments, the system stores the DNS telemetry data in an active cache (e.g., the active part of the ADNS telemetry cache for the particular telemetry window). At 630, the system determines whether more DNS response(s) are to be received or evaluated. For example, the system determines whether another DNS response is to be received or evaluated based at least in part on a determination of whether the particular telemetry window has lapsed (e.g., in which case a further iteration of 605-630 or process 600 is processed). In response to determining that another DNS response(s) is to be received or evaluated, process 600 returns to 610 and process 600 iterates over 610-630 until no further DNS responses are to be received or evaluated. At 635, a determination is made as to whether process 600 is complete. In some embodiments, process 600 is determined to be complete in response to a determination that no further DNS telemetry data is to be cached, no further DNS records are obtained, no further DNS telemetry cache entries are to be reported/sent to a cloud security service, an administrator indicates that process 600 is to be paused or stopped, etc. In response to a determination that process 600 is complete, process 600 ends. In response to a determination that process 600 is not complete, process 600 returns to 605.

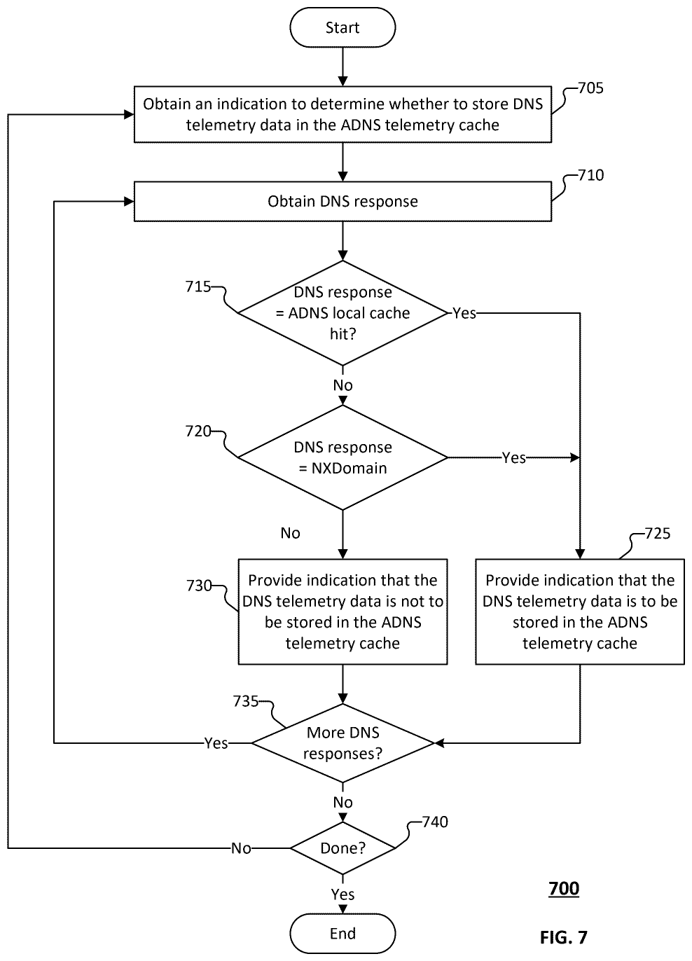

FIG. 7 is a flow diagram of a method for determining whether to store DNS telemetry data in an ADNS telemetry cache according to various embodiments. In some embodiments, process 700 is implemented at least in part by system 100 of FIG. 1, system 200 of FIG. 2, and/or system 300 of FIG. 3. Process 700 may be implemented by a system providing security service to an inline security entity, such as to a firewall (e.g., a next generation firewall). In some embodiments, process 700 is invoked by process 600, such as at 620.

At 705, the system obtains an indication to determine whether to store DNS telemetry data in the ADNS telemetry cache. For example, process 700 receives the indication from the system or service implementing process 600.

At 710, the system obtains the DNS response, or information pertaining to the DNS response. At 715, the system determines whether the DNS response is an ADNS local cache hit. In response to determining that the DNS response is an ADNS local cache hit, process 700 proceeds to 725. Conversely, in response to determining that the DNS response is not an ADNS local cache hit, process 700 proceeds to 720. At 720, the system determines whether the DNS response corresponds to an NXDomain response. In response to determining that the DNS response corresponds to an NXDomain response, process 700 proceeds to 725. Conversely, in response to determining that the DNS response does not correspond to an NXDomain response, process 700 proceeds to 730. At 725, the system provides an indication that the DNS telemetry data is to be stored in the ADNS telemetry cache. For example, the system provides the indication to the process, system, or service that invoked process 700. At 730, the system provides an indication that the DNS telemetry data is not to be stored in the ADNS telemetry cache. For example, the system provides the indication to the process, system, or service that invoked process 700. At 735, the system determines whether more DNS response(s) are to be received or evaluated. In response to determining that another DNS response(s) is to be received or evaluated, process 700 returns to 710 and process 700 iterates over 710-730 until no further DNS responses are to be received or evaluated. At 740, a determination is made as to whether process 700 is complete. In some embodiments, process 700 is determined to be complete in response to a determination that no further DNS telemetry data is to be cached, no further DNS records are obtained, no further DNS records are to be evaluated (e.g., as to whether to report corresponding DNS telemetry data), no further DNS telemetry cache entries are to be reported/sent to a cloud security service, an administrator indicates that process 700 is to be paused or stopped, etc. In response to a determination that process 700 is complete, process 700 ends. In response to a determination that process 700 is not complete, process 700 returns to 705.

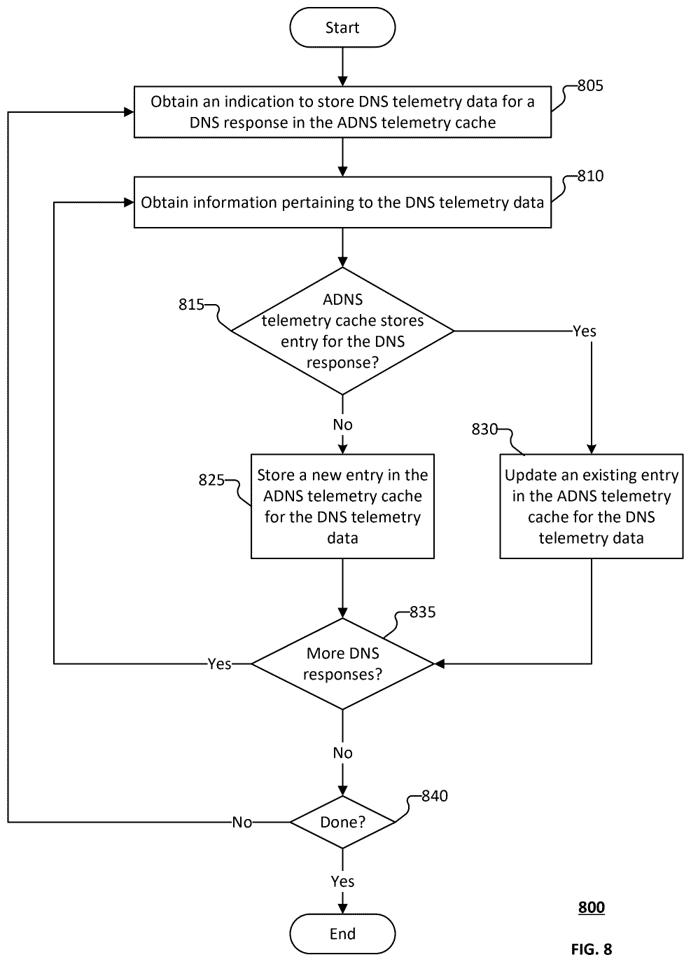

FIG. 8 is a flow diagram of a method for storing DNS telemetry data in an ADNS telemetry cache according to various embodiments. In some embodiments, process 800 is implemented at least in part by system 100 of FIG. 1, system 200 of FIG. 2, and/or system 300 of FIG. 3. Process 800 may be implemented by a system providing security service to an inline security entity, such as to a firewall (e.g., a next generation firewall). In some embodiments, process 800 is invoked by process 600, such as at 625.

At 805, the system obtains an indication to store DNS telemetry data for a DNS response in the ADNS telemetry cache. For example, the system obtains the indication from the system or service implementing 625 of process 600. At 810, the system obtains information pertaining to the DNS telemetry data. At 815, the system determines whether the ADNS telemetry cache stores an entry for the DNS response. In response to determining that the ADNS stores entry for the DNS response, process 800 proceeds to 825. Conversely, in response to determining that the ADNS does not store an entry for the DNS response, process 800 proceeds to 830. At 825, the system stores a new entry in the ADNS telemetry cache for the DNS telemetry data. At 830, the system updates an existing entry in the ADNS telemetry cache for the DNS telemetry data. In some embodiments, the system updates the existing entry to update a count, such as a count for a number of times that a particular DNS response has been observed during a particular time interval, or a count for a number of times that a DNS response has been observed for a particular domain during the particular time interval. At 835, the system determines whether more DNS response(s) are to be stored. For example, the system determines whether another DNS response(s) has been observed (e.g., received) during a particular time interval. In response to determining that another DNS response(s) is to be received or evaluated, process 800 returns to 810 and process 800 iterates over 810-830 until no further DNS responses are to be received or evaluated. At 840, a determination is made as to whether process 800 is complete. In some embodiments, process 800 is determined to be complete in response to a determination that no further DNS telemetry data is to be cached, no further DNS records are obtained, no further DNS records are to be evaluated (e.g., as to whether to report corresponding DNS telemetry data), no further DNS telemetry cache entries are to be reported/sent to a cloud security service, an administrator indicates that process 800 is to be paused or stopped, etc. In response to a determination that process 800 is complete, process 800 ends. In response to a determination that process 800 is not complete, process 800 returns to 805.

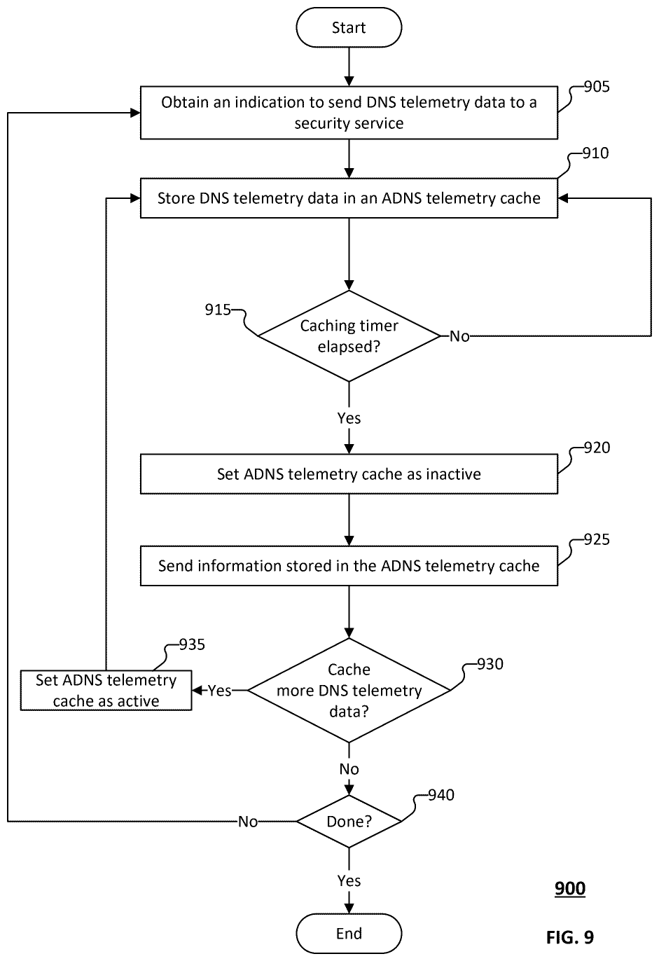

FIG. 9 is a flow diagram of a method for providing DNS telemetry data according to various embodiments. In some embodiments, process 900 is implemented at least in part by system 100 of FIG. 1, system 200 of FIG. 2, and/or system 300 of FIG. 3. Process 900 may be implemented by a system providing security service to an inline security entity, such as to a firewall (e.g., a next generation firewall).

At 905, the system obtains an indication to send DNS telemetry data to a security service. For example, the system obtains an indication that the ADNS telemetry cache data is to be provided to the security service. At 910, the system stores DNS telemetry data in an ADNS telemetry cache. For example, the system stores the DNS telemetry data contemporaneous with observing DNS responses (e.g., obtaining or intercepting the DNS response at a security entity). At 915, the system determines whether the caching timer has elapsed. The caching timer is configured for a particular time interval. In some embodiments, the caching timer is configurable. In response to determining that the caching timer has not elapsed, process 900 returns to 910 and process 900 iterates over 910-915 and stores telemetry data for observed DNS records (e.g., intercepted DNS records) until the caching timer has elapsed. Conversely, in response to determining that the caching timer has elapsed, process 900 proceeds to 920. At 920, the system the ADNS telemetry cache as inactive. For example, the system toggles the ADNS telemetry cache that was set as active before the caching timer elapsed and for which DNS telemetry data has been stored to be inactive, and toggles the ADNS telemetry cache that was set as inactive before the caching timer elapsed and for which DNS telemetry data has been stored to be active (e.g., so that DNS telemetry data can be stored in such ADNS telemetry cache during the next particular time interval). At 925, the system sends information (e.g., ADNS telemetry cache data) stored in the ADNS telemetry cache. At 930, the system determines whether to cache more DNS telemetry data. For example, the system determines whether the next particular time interval has expired and whether to toggle the inactive ADNS telemetry cache to be set as active. In response to determining that more DNS telemetry data is to be cached, process 900 proceeds to 935 at which the ADNS telemetry cache is set as active. Thereafter, process 900 returns to 910 and iterates over 910-930 until no further DNS telemetry data is to be cached. At 940, a determination is made as to whether process 900 is complete. In some embodiments, process 900 is determined to be complete in response to a determination that no further DNS telemetry data is to be cached, no further DNS records are obtained, no further DNS records are to be evaluated (e.g., as to whether to report corresponding DNS telemetry data), no further DNS telemetry cache entries are to be reported/sent to a cloud security service, an administrator indicates that process 900 is to be paused or stopped, etc. In response to a determination that process 900 is complete, process 900 ends. In response to a determination that process 900 is not complete, process 900 returns to 905.

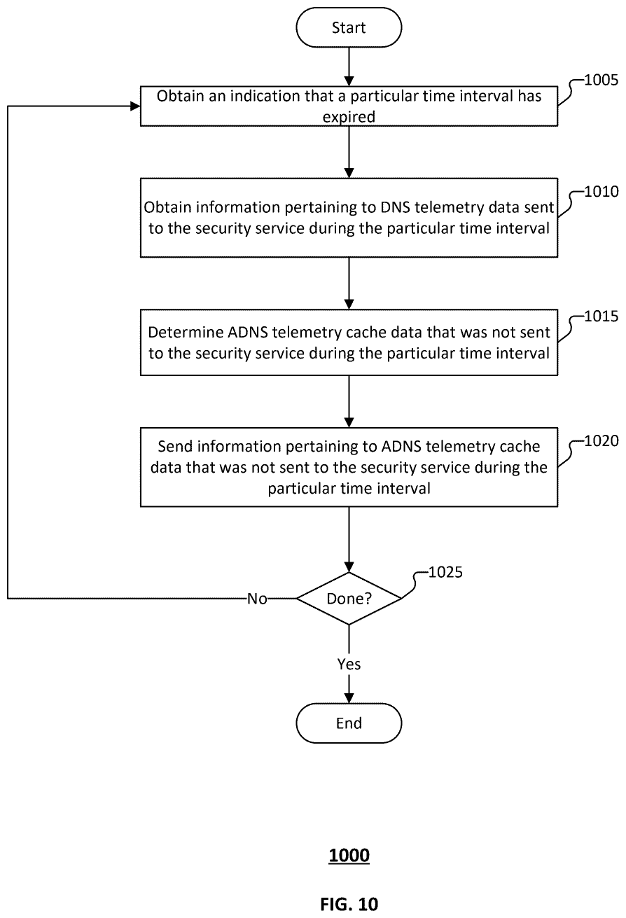

FIG. 10 is a flow diagram of providing information pertaining to ADNS telemetry cache according to various embodiments. In some embodiments, process 1000 is implemented at least in part by system 100 of FIG. 1, system 200 of FIG. 2, and/or system 300 of FIG. 3. Process 1000 may be implemented by a system providing security service to an inline security entity, such as to a firewall (e.g., a next generation firewall).

According to various embodiments, process 1000 invoked in response to determining that some entries in an ADNS telemetry cache were not reported/sent to cloud service during the particular time interval during which the ADNS telemetry cache is set as inactive (e.g., when the system reports/sends the DNS telemetry data to a cloud security service). In some embodiments, process 1000 is invoked whenever the end of the time interval (e.g., the lapsing of the caching timer) during which the ADNS telemetry data is stored in the ADNS telemetry cache.

According to various embodiments, the system stores statistics pertaining to DNS telemetry data that is not reported or sent to the security service (e.g., a cloud security service) during one of the particular time interval during the telemetry data caching cycle. The system can locally store statistics of data not sent and the system can send the statistics data upon request (e.g., upon a request from the cloud security service) or according to a statistics reporting cycle (e.g., a cycle according to a second time interval).

At 1005, the system obtain an indication that a particular time has expired. At 1010, the system obtains information pertaining to DNS telemetry data sent to the security service during the particular time interval.

At 1015, the system determines ADNS telemetry cache data that was not sent to the security service during the particular time interval. For example, the system determines the DNS telemetry data in the ADNS telemetry cache that had not been reported to the cloud security platform, such as in the event that the corresponding telemetry window lapsed/expired before all the entries in the ADNS telemetry cache could be uploaded to the cloud security platform. In some embodiments, the system determines statistical information pertaining to the ADNS telemetry cache and the reporting of DNS telemetry data stored in the ADNS telemetry cache. At 1020, the system sends information pertaining to the ADNS telemetry cache data that was not sent to the security service during the particular time interval. At 1025, a determination is made as to whether process 1000 is complete. In some embodiments, process 1000 is determined to be complete in response to a determination that no further DNS telemetry data is to be cached, no further DNS records are obtained, no further DNS records are to be evaluated (e.g., as to whether to report corresponding DNS telemetry data), no further DNS telemetry cache entries are to be reported/sent to a cloud security service, an administrator indicates that process 1000 is to be paused or stopped, etc. In response to a determination that process 1000 is complete, process 1000 ends. In response to a determination that process 1000 is not complete, process 1000 returns to 1005.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
cache advanced domain name system (ADNS) telemetry data in an ADNS telemetry cache in a local security platform;
send the cached ADNS telemetry data from the local security platform to a cloud security service in near real time for a real-time threat analysis using ADNS telemetry; and
a memory coupled to the one or more processors and configured to provide the one or more processors with instructions.

2. The system of claim 1, wherein the local security platform is a next generation firewall.

3. The system of claim 1, wherein the ADNS telemetry cache comprises a first telemetry cache and a second telemetry cache.

4. The system of claim 3, wherein the first telemetry cache and the second telemetry cache are toggled between an active cache and an inactive cache.

5. The system of claim 4, wherein at a particular time the first telemetry cache is configured as the active cache and the second telemetry cache is configured as the inactive cache.

6. The system of claim 4, wherein the first telemetry cache and the second telemetry cache are toggled according to a predefined time interval.

7. The system of claim 6, wherein the predefined time interval is 1 second.

8. The system of claim 6, wherein the predefined time interval is updated at run time via a command input.

9. The system of claim 6, wherein the predefined time interval is less than or equal to 5 seconds.

10. The system of claim 4, wherein a size of the active cache and the inactive cache is configurable.

11. The system of claim 4, wherein the active cache and the inactive cache respectively have sufficient space to store 10240 entries.

12. The system of claim 4, wherein the active cache and the inactive cache respectively have sufficient space to store a predefined number of entries.

13. The system of claim 4, wherein sending the cached ADNS telemetry data to the cloud security service comprises:
communicate, during a particular time interval, to the cloud service ADNS telemetry data stored in the inactive cache; and
store, during a particular time interval, ADNS telemetry information in the active cache in response to the ADNS local cache being queried and hit during the particular time interval.

14. The system of claim 13, wherein communicating, during a particular time interval, to the cloud service ADNS telemetry data stored in the inactive cache comprises:
determine that the particular time interval expired;
in response to determining that the particular time interval expired,
identify entries in the inactive cache that were not successfully communicated to the cloud security service during the time interval; and
discard the entries in the inactive cache that were not successfully communicated to the cloud security service.

15. The system of claim 13, wherein the one or more processors are further configured to:
in response to expiration of the particular time interval, provide to a cloud security service information determined based at least in part on the entries in the inactive cache that were not successfully communicated to the cloud security service during the particular time interval.

16. The system of claim 15, wherein the information determined based at least in part on the entries in the inactive cache that were not successfully communicated to the cloud security service during the particular time interval comprises: statistics about the entries not being sent to the cloud security service during the particular time interval.

17. The system of claim 15, wherein the information comprises aggregated statistical information for the entries in the inactive cache that were not successfully communicated to the cloud security service during the particular time interval.

18. The system of claim 1, wherein the ADNS telemetry cache stores the ADNS telemetry data in a key-value mapping.

19. The system of claim 18, wherein a key in the key-value mapping corresponds to a cache line, and a value in the key-value mapping stores information pertaining to a number of query hits during a particular time interval.

20. The system of claim 18, wherein a key for an entry in the key-value mapping stores a concatenated string comprising rrname information, rrtype information, rrdata information, verdict information, and action information.

21. The system of claim 18, wherein a value for an entry in the key-value mapping stores (i) an ADNS local cache hit count for the associated domain during a particular time interval, (ii) a first timestamp indicating a time at which the ADNS local cache was first queried for the domain during the particular time interval, and (iii) a second timestamp indicating a time at which the ADNS local cache was last queried for the domain during the particular time interval.

22. The system of claim 18, wherein an entry in the key-value mapping corresponds to a non-existent domain (NXDomain) for a DNS query processed during a particular time interval, a key for the entry comprises information pertaining to the NXDomain, and a value for the entry comprises information pertaining to a number of query hits during the particular time interval.

23. The system of claim 22, wherein the key for the entry associated with the NXDomain comprises a concatenated string comprising domain information, server IP information, and address information.

24. The system of claim 22, wherein the value for the entry associated with the NXDomain comprises a (i) a NXDomain count; (ii) a first timestamp indicating a time at which the ADNS local cache was first queried for the domain during the particular time interval; and (iii) a second timestamp indicating a time at which the ADNS local cache was last queried for the domain during the particular time interval.

25. A method, comprising:
caching advanced domain name system (ADNS) telemetry data in an ADNS telemetry cache in a local security platform; and
sending the cached ADNS telemetry data from the local security platform to a cloud security service in near real time for a real-time threat analysis using ADNS telemetry.

26. A computer program product embodied in a non-transitory computer readable medium and comprising computer instructions for:
caching advanced domain name system (ADNS) telemetry data in an ADNS telemetry cache in a local security platform; and
sending the cached ADNS telemetry data from the local security platform to a cloud security service in near real time for a real-time threat analysis using ADNS telemetry.
